(19) United States
(12) Patent Application Publication
(10) Pub. No.: US 2015/0074564 A1
(43) Pub. Date: Mar. 12, 2015

(54) FEEDBACK FOR CURSOR LOCATION IN MULTIPLE MONITOR DEVICE CONTEXTS

(71) Applicant: Lenovo (Singapore) Pte. Ltd., Singapore (SG)

(72) Inventor: Corinna Paine Proctor, Raleigh, NC (US)

(73) Assignee: Lenovo (Singapore) Pte. Ltd., Singapore (SG)

(21) Appl. No.: 14/022,776

(22) Filed: Sep. 10, 2013

(51) Int. Cl. G06F 3/0481

(52) U.S. Cl. CPC G06F 3/04812
USPC 715/761

(57) ABSTRACT

An aspect provides a method, including: determining a location of a cursor within a display area provided by multiple monitors; defining in the display area a boundary associated with one or more monitors of the multiple monitors; determining that the location of the cursor is proximate to a predetermined location associated with the boundary; and responsive to the determining, providing a notification to a user. Other aspects are described and claimed.

### BACKGROUND

Information handling devices (“devices”), for example laptop and desktop computers, etc., are often used in a context where multiple monitors are employed. A typical scenario includes for example a desktop user that has configured his or her system in an “extended desktop” mode. Another example includes a laptop or other smaller/mobile device adapted to utilize an additional monitor, e.g., as plugged into a communication port of the smaller/mobile device. In such use contexts, a user may extend the desktop to employ multiple monitors (e.g., two or more) via adjusting a property of the desktop settings (e.g., in a WINDOWS operation system) to take advantage of the additional hardware available (i.e., the additional monitor(s)).

Users employ multiple monitors/displays for a variety of reasons, for example working with multiple applications simultaneously, etc. While the multiple monitors provide for convenience as to display of a large amount of information, which is useful in many contexts, the volume of displayed material may be difficult to manage for a variety of reasons.

### BRIEF SUMMARY

In summary, one aspect provides a method, comprising: determining a location of a cursor within a display area provided by multiple monitors; defining in the display area a boundary associated with one or more monitors of the multiple monitors; determining that the location of the cursor is proximate to a predetermined location associated with the boundary; and responsive to the determining, providing a notification to a user.

Another aspect provides an information handling device, comprising: one or more processors; a memory device accessible to the one or more processors and storing code executable by the one or more processors to: determine a location of a cursor within a display area provided by multiple monitors; define in the display area a boundary associated with one or more monitors of the multiple monitors; determine that the location of the cursor is proximate to a predetermined location associated with the boundary; and thereafter provide a notification to a user.

A further aspect provides a program product, comprising: a storage device having computer readable program code stored therewith, the computer readable program code comprising: computer readable program code configured to determine a location of a cursor within a display area provided by multiple monitors; computer readable program code configured to define in the display area a boundary associated with one or more monitors of the multiple monitors; computer readable program code configured to determine that the location of the cursor is proximate to a predetermined location associated with the boundary; and computer readable program code configured to thereafter provide a notification to a user.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates an example operating environment including multiple monitors.

FIG. 3 illustrates an example method of feedback for cursor location in multiple monitor device contexts.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Problems users face when using multiple monitors include losing track of the cursor location and mis-targeting items located in border or boundary areas in the display, i.e., a transition area between screens. Border and boundary are used interchangeably herein. Monitor, screen and display are used interchangeably herein. Cursor is defined herein to mean an on-screen indicator that indicates the location of a navigation control feature, e.g., a mouse pointer.

When using a single monitor, users become accustomed to rapidly targeting the four corners of a screen in order to move the cursor to a desired button or function, such as a scroll bar which is docked to the far right. However, when using multiple monitors, the display area is more complex, as it traverses more than one physical display device or screen. As such, common scenarios such as cursor drift may occur and become more problematic than usual.

For example, a cursor may drift across the border or boundary area between two screens. Thus, instead of having a single bounded display area, the cursor may transition itself to a secondary monitor, escaping the notice of the user. As this happens, users lose their position and orientation with respect to navigating about the display area.

Additionally, with additional monitors in use, users are no longer provided the quick targeting opportunity to find/navigate to common targets, e.g., a scroll bar, because the cursor too easily breaks the border and moves to the second display. Thus, mis-targeting of items located near boundaries, e.g., a scroll bar, is a common problem. In many common tasks such as review and reading of documents, the cursor's exact position is not known or not easily controlled. This requires a user to pick up the location of the cursor prior to using it and/or reposition or re-target items easily located in a single display context.

Accordingly, embodiments provide a solution that includes adding a feedback mechanism in the form of a notification regarding the location of the cursor. An embodiment may determine that the cursor is proximate to a predetermined location associated with the boundary. In one embodiment, the notification is a haptic notification provided to the user that the cursor is within a predetermined distance of a boundary, e.g., the cursor is within a transition area between two display screens. This apprises the user of the location of the cursor relative to the transition are and allows the user to take notice that the cursor is entering a problematic area, as outlined above. In one embodiment, the haptic feedback may be provided to a user input device used to position or relocate the cursor, such as a TRACKPOINT pointing stick, a touchpad, or a traditional mouse. The haptic feedback may subtly signal to the user that the cursor is about to cross the boundary to another (e.g., a second) display.

The notification may take other forms, for example a subtle vibration, an audible notification, a visual notification, requiring additional force to move the cursor over the boundary over to the other display, or suitable combinations of the foregoing. In an embodiment, the feedback feature is neither loud nor abrasive and does not cause irritation or stress to the user. Such a feedback mechanism provides a simple way to keep the cursor located where it is intended to be positioned at all times. In an embodiment, if users find the feedback to be an irritant, it could be disabled, e.g., via a hardware mouse driver setting.

The illustrated example embodiments will be best understood by reference to the figures. The following description is intended only by way of example, and simply illustrates certain example embodiments.

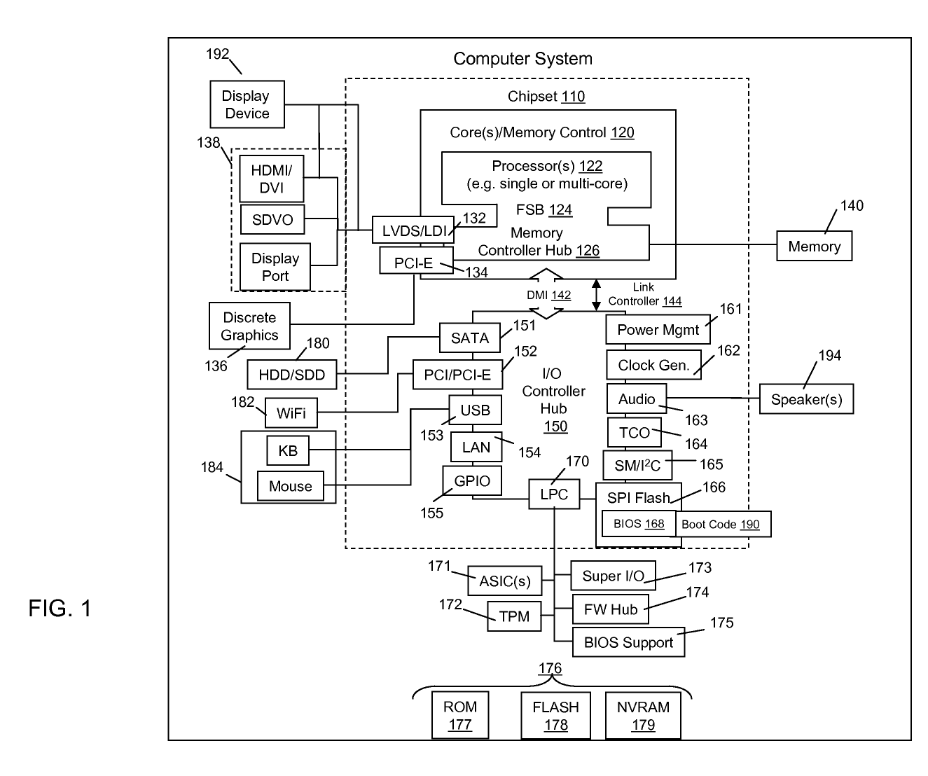

FIG. 1, for its part, depicts a block diagram of an example of information handling device circuits, circuitry or components. The example depicted in FIG. 1 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 1.

The example of FIG. 1 includes a so-called chipset 110 (a group of integrated circuits, or chips, that work together, chipsets) with an architecture that may vary depending on manufacturer (for example, INTEL, AMD, ARM, etc.). The architecture of the chipset 110 includes a core and memory control group 120 and an I/O controller hub 150 that exchanges information (for example, data, signals, commands, et cetera) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture.

In FIG. 1, the memory controller hub 126 interfaces with memory 140 (for example, to provide support for a type of RAM that may be referred to as “system memory” or “memory”). The memory controller hub 126 further includes a LVDS interface 132 for a display device 192 (for example, a CRT, a flat panel, touch screen, et cetera). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, 180 et cetera), a PCI-E interface 152 (for example, for wireless connections 182), a USB interface 153 (for example, for devices 184 such as a digitizer, keyboard, mice, cameras, phones, microphones, storage, other connected devices, et cetera), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

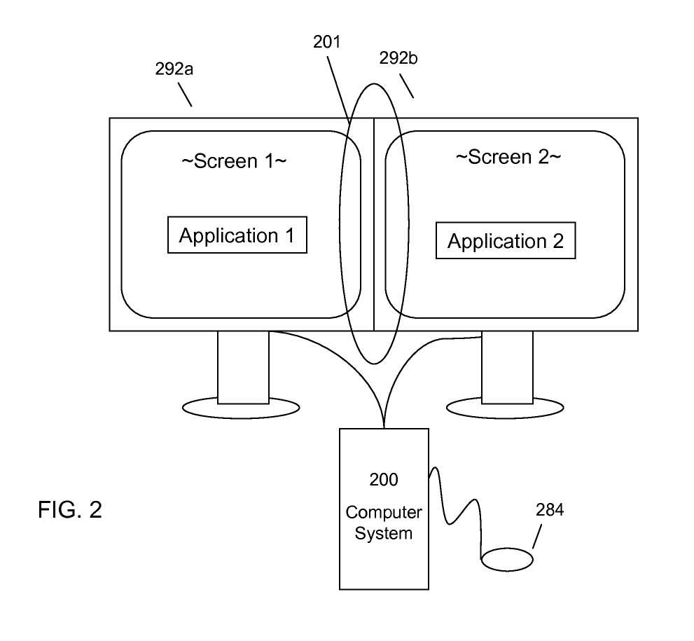

Information handling devices, as for example outlined in FIG. 1, may operate in a multiple monitor mode, i.e. where two or more monitors or display screens are used to display data. In such a use context, an example of which is outlined in FIG. 2, a device such as computer system 200 may be operatively coupled to two monitors 292a, 292b, such that data, e.g., application 1 and application 2, may be displayed for a user. The user navigates within the display area, comprised of monitors 292a, 292b, using a pointing device 284 such as a mouse, touch pad, track point, etc.

In such a multiple monitor environment, a border or boundary, e.g., 201, may include a portion of the display area of monitors 292a, 292b, where a transition between the two occurs. This border 201 forms because the device 200, while logically splitting the two screens, is nonetheless bound to the physical attributes of the monitors 292a, 292b. Therefore, when the location of the cursor enters the border area 201, at a certain point, the location of the cursor is transitioned by the device 200 between the monitors 292a, 292b. While to the device 200 this takes place as a smooth transition, visually it is represented by a jump by virtue of the monitors' 292a, 292b physical attributes (e.g., bezel areas). Thus, what is a simple, small movement logically, visually is represented as a large movement of the location of the cursor.

When such a transition movement is intended it is easy enough to handle. However, there are situations in which the transition of the cursor location between monitors 292a, 292b causes difficulty. Examples include cursor drift (i.e., when the cursor moves without explicit user input) and mis-targeting, as outlined briefly above.

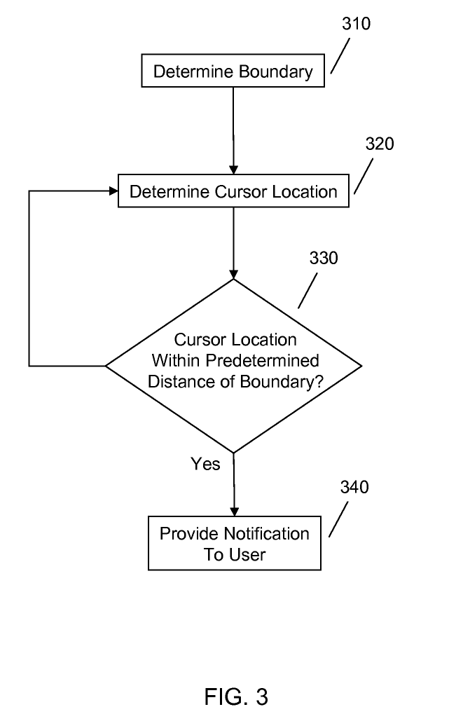

Accordingly, referring to FIG. 3, an embodiment provides a method of feedback for cursor location in multiple monitor device contexts. An embodiment determines one or more boundaries for the display area at 310, e.g., area 201 of FIG. 2. This permits an embodiment to compare a current cursor location to a boundary. More than one boundary may be defined, e.g., when more than two monitors are utilized.

With a boundary area defined, e.g., per x, y, coordinates of a monitor(s) display area, an embodiment may determine the current cursor location 320 such that the current cursor location may be compared with the boundary. If the cursor location is within a predetermined distance of the boundary (e.g., is within the boundary), as determined at 330, an embodiment may provide a notification to the user at 340. Otherwise, an embodiment may continue to determine or track the current cursor location for comparison with the boundary.

The notification provided at 340 may take a variety of forms. In one embodiment, a notification may take the form of haptic feedback. This haptic feedback may be provided to a user input device (e.g., mouse, pointing stick, touchpad, digitizer, etc.) such that it is noticeable to the user. A haptic feedback notification may be produced in a variety of ways (e.g., via hardware actuator). The user will thus be apprised of the location of the cursor and that it is within a predetermined distance of the boundary, e.g., a notification that the cursor has entered the boundary.

The notification may take other forms, including multiple notifications. In one embodiment, in addition to or as an alternative to, haptic feedback, e.g., produced at a user input device, an embodiment may require additional input. For example, an embodiment may require additional, e.g., confirmatory, input from the user in order to relocate the cursor position, e.g., from one monitor to another. This additional input may in turn take a variety of forms. For example, responsive to determining that the cursor is located within a boundary, e.g., at 330 of FIG. 3, an embodiment may require that the user apply additional force (e.g., to a pointing stick), provide additional cursor speed (approximating a virtual “speed bump” that must be overcome) or the like in order to transition the cursor location from one monitor to another.

As another example, an embodiment may require an additional input in the form of repeated cursor movement in order to transition the cursor location between monitors. For example, a user may be required to first attempt to transition the cursor between monitors, with the cursor not transitioning, followed by a repeated movement of the cursor into the boundary area (e.g., within a predetermined time) prior to permitting the cursor to transition between monitors. Thus, the user confirms that the cursor is intended to be relocated to the other monitor.

By requiring additional input, the notification will not only apprise the user that the cursor has approached or entered a boundary, but will also serve to prevent the cursor from being placed on another monitor without user confirmation. This may be useful in several contexts, e.g., when the user wishes to target a scroll bar located in the border area of a display screen, when the cursor is drifting (independent of user input), etc.

In the event that the notification(s) are undesirable, the notification(s) may be selectively disabled (or enabled), e.g., by user input or automatically through inference. For example, a user may manually enable or disable notifications, e.g., by modifying properties settings in a desktop operating system. Additionally or in the alternative, an embodiment may leverage user behavior to learn if a notification should be enabled/disabled. For example, an embodiment may take a user action, e.g., repeated transitioning between screens, as an indication that the user is intentionally repositioning the cursor location between monitors and thus disable the notification(s).

Additionally, an embodiment may enable one notification and disable another notification. For example, a haptic notification may remain enabled while another notification, e.g., a requirement for additional input, may be disabled. Additionally, user input or inferential learning may be utilized to modify the boundary or boundaries provided. For example, an embodiment may enlarge or shrink a boundary or create or remove boundaries based on a variety of factors. Thus, a user may modify a boundary or a boundary may be modified (e.g., enlarged, reduced, created, removed) based on inferences, e.g., addition of a monitor, behavior of a hardware device (e.g., a particular mouse or pointing stick tends to drift in a certain direction), etc.

Therefore, as may be appreciated from the above, an embodiment provides for feedback for cursor location in multiple monitor device contexts. Various embodiments may provide for notification(s) as to current cursor location with respect to one or more boundaries or boundary areas within a multiple monitor display. A user or an embodiment may modify the boundaries and/or the notifications to suit particular contexts, as described herein.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
determining a location of a cursor within a display area provided by multiple monitors;
defining in the display area a boundary associated with one or more monitors of the multiple monitors;
determining that the location of the cursor is proximate to a predetermined location associated with the boundary; and
responsive to the determining, providing a notification to a user.

2. The method of claim 1, wherein the boundary is associated with a transition between two of the multiple monitors.

3. The method of claim 2, wherein the boundary comprises multiple boundaries, each of the multiple boundaries being associated with a transition between two of the multiple monitors.

4. The method of claim 3, wherein the notification comprises two or more notifications;
each of the two or more notifications being associated with a different boundary.

5. The method of claim 1, wherein the notification is selected from the group of notifications consisting of: an audible notification, a visual notification, a haptic notification and a requirement for additional input to permit cursor movement.

6. The method of claim 1, wherein the notification is a haptic notification.

7. The method of claim 1, further comprising disabling the notification responsive to user input.

8. The method of claim 5, wherein the requirement for additional input to permit cursor movement comprises requiring additional input to permit the cursor to be transitioned between monitors.

9. The method of claim 8, wherein the requirement for additional input to permit cursor movement comprises requiring speed of cursor movement above a predetermined threshold to transition the cursor between monitors.

10. The method of claim 8, wherein the requirement for additional input to permit cursor movement comprises requiring repeated motion input to transition the cursor between monitors.

11. An information handling device, comprising:
one or more processors;
a memory device accessible to the one or more processors and storing code executable by the one or more processors to:
determine a location of a cursor within a display area provided by multiple monitors;
define in the display area a boundary associated with one or more monitors of the multiple monitors;
determine that the location of the cursor is proximate to a predetermined location associated with the boundary; and
thereafter provide a notification to a user.

12. The information handling device of claim 11, wherein the boundary is associated with a transition between two of the multiple monitors.

13. The information handling device of claim 12, wherein the boundary comprises multiple boundaries, each of the multiple boundaries being associated with a transition between two of the multiple monitors.

14. The information handling device of claim 13, wherein the notification comprises two or more notifications;
each of the two or more notifications being associated with a different boundary.

15. The information handling device of claim 11, wherein the notification is selected from the group of notifications consisting of: an audible notification, a visual notification, a haptic notification and a requirement for additional input to permit cursor movement.

16. The information handling device of claim 11, wherein the notification is a haptic notification.

17. The information handling device of claim 11, wherein the code is further executable by the one or more processors to disable the notification responsive to user input.

18. The information handling device of claim 15, wherein the requirement for additional input to permit cursor movement comprises requiring additional input to permit the cursor to be transitioned between monitors.

19. The information handling device of claim 18, wherein the requirement for additional input to permit cursor movement comprises requiring additional input in a form selected from the group of:
requiring speed of cursor movement above a predetermined threshold to transition the cursor between monitors; and
requiring repeated motion input to transition the cursor between monitors.

20. A program product, comprising:
a storage device having computer readable program code stored therewith, the computer readable program code comprising:
computer readable program code configured to determine a location of a cursor within a display area provided by multiple monitors;
computer readable program code configured to define in the display area a boundary associated with one or more monitors of the multiple monitors;
computer readable program code configured to determine that the location of the cursor is proximate to a predetermined location associated with the boundary; and
computer readable program code configured to thereafter provide a notification to a user.
